(19) United States
(12) Patent Application Publication
(10) Pub. No.: US 2013/0295549 A1
(43) Pub. Date: Nov. 7, 2013

(54) One-Handed, Open Grip and Pivotable Tablet Support Device

(71) Applicant: Floyd Hills, Chesapeake, VA (US)

(72) Inventor: Floyd Hills, Chesapeake, VA (US)

(21) Appl. No.: 13/748,683

(22) Filed: Jan. 24, 2013

Related U.S. Application Data
(60) Provisional application No. 61/643,641, filed on May 7, 2012.

(51) Int. Cl. G09B 7/00

(52) U.S. Cl. CPC G09B 7/00
USPC 434/379

(57) ABSTRACT

Disclosed is an electronic tablet computer carrier that comprises a frame adapted to surround the rear of a tablet computer and form over the peripheral edges thereof to affect attachment thereto. The backside surface of the frame comprises a centrally located pivoting member and connector means to allow a user to support the frame and a tablet computer with a single hand behind the frame and without gripping the assembly. The pivoting member is an inner and outer member pivotably connected together, whereby the inner member is secured to the frame backside and the outer member freely pivots therefrom along a plane parallel to the frame backside surface. The connectors are positioned along the outer pivoting member the join the assembly with a corresponding glove or strap support worn by or attached to the user, thereby providing support for a tablet without gripping its edges or using two hands.

### CROSS REFERENCE TO RELATED APPLICATION

This application claims the benefit of U.S. Provisional Application No. 61/643,641 filed on May 7, 2012, entitled “Electronic Tablet Glove Holder.” The above identified patent application is herein incorporated by reference in its entirety to provide continuity of disclosure.

### BACKGROUND OF THE INVENTION

1. Field of the Invention

The present invention relates to electronic device holders and tablet protectors. More specifically, the present invention pertains to a tablet case having a backside swivel joint that connects to a handheld connector such that the tablet is rotatably supported by a user's hand for teaching and presentation purposes.

Tablet computers are handheld personal computers that offer a user a lightweight electronic device with direct input, where the device is appropriate for recreational, educational, or commercial use. Most tablets include a large touchscreen having a chassis structure housing internal electronic components, where the tablet dimensions include a given screen surface area and a minimal chassis thickness to reduce weight and bulkiness of the device. Tablets are well described in the art of electronic computers, as are supports and protective frames therefor. Tablet protectors and covers generally connect to the tablet in a given manner to offer protection of the tablet structure or the touchscreen interface. Most of these are formed structures that snap onto or otherwise connect to the tablet to provide impact attenuation or improved grip.

A common drawback of tablet computers is the inherent ergonomic issues of both supporting the enlarged handheld device while attempting to making inputs. To properly interact with the tablet, most tablets need to be held relatively upright; however the limited gripping interface of most tablets impacts the ease with which one can support the tablet over a given period, or while attempting to simultaneously support and interact with the device. Obtaining adequate purchase of a tablet is dependent on its given design, the task required of the tablet by the user, and the physical limitations of the user in supporting the tablet. For those with carpel tunnel or limited hand strength, supporting a tablet by its edges and interacting with the tablet can be burdensome. Further still, those using the device as a productivity tool for teaching or commercial use can find it difficult to both support the tablet and make inputs at the same time. The act of even holding the device by its peripheral edge over a long period can be tiresome on the hands of the user.

It is therefore submitted that there exists a need for an improved means of purchase of a tablet computer, particularly for those users utilizing the tablet for teaching and as a productivity tool where use while standing or in motion may be required. The present invention discloses a tablet computer carrier that snaps about the backside frame of the given tablet and provides a pivoting, grip-free interface with which a user can slide his or her hand therein and support the tablet with one hand while making inputs with the other. The backside pivoting mechanism removably connects to a glove or hand strap structure, whereby the user is not required to squeeze the edges of the tablet or balance the tablet on one hand, but rather the device is pivotably connected to the palm of one hand. The user's free hand can then make inputs or engage in other activities, while the hand in connection with the tablet remains in a rested state while in connection with the tablet.

2. Description of the Prior Art

Devices have been disclosed in the prior art that relate to tablet computers, covers and supports therefor. These include devices that have been patented and published in patent application publications, and generally relate to tablet carriers with distinctly different characteristics and goals. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,360,928 to Russo discloses a universal holder device for mounting a calculator tool onto a user's hand, whereby the hand attachment is a strap with an extended post that is excepted by a tool attachment element. The tool attachment element attaches to the tool to be rotated and receives the strap post through a bore, whereby the tool and the tool attachment are capable of rotating about the post freely for the user to operate the tool and reposition it as necessary. The strap secures about a user's hand and the post frictionally engages the hand attachment for removable engagement. The Russo device, while disclosing a means of supporting a calculator tool on a wearer's hand by way of a rotatable strap, fails to contemplate a removable glove that snaps to a rotatable pivot element along the back of a tablet cover.

Another such device is U.S. Patent Application Publication No. 2011/0267748 to Lane, which discloses a holder for an electronic device that comprises a cover adapted to couple with the electronic device having a back panel and a holding mechanism attached to the back panel. The holding mechanism is rotatable and attaches to a strap assembly. The holding mechanism secures within a circular aperture along the back panel to allow at least ninety degrees of rotation. The panel secures to the electronic device and allows the device to be operated by one hand and held by a second using the strap assembly. The Lane device, while disclosing an electronic device holder that provides rotation thereof, fails to disclose a removable glove that attaches to a rotatable mechanism along the back of a computer tablet cover as provided by the present invention. The present invention provides a user with a readily donned glove that snaps to the rotatable tablet cover for teaching, presenting and tablet operating purposes.

U.S. Patent Application Publication No. 2010/0327030 to Yang discloses a portable binder having a rotating frame, whereby the frame is supported by a pedestal and base connected to strap supported by a user. The frame rotates about a shaft such that the frame can freely rotate, providing the ability to tilt the frame and its contents towards a user as desired. The binder provides connection about an electronic device such as a music player or cellular phone device, while the strap secure around a user's arm while in operation. The Yang device, while disclosing a rotating frame for supporting an electronic device, does not offer a means to support the frame by hand while teaching or engaging in a work activity, but rather provides a carrying case for runners and joggers.

Finally, U.S. Patent Application Publication No. 2011/0247959 to Nelson discloses a personal electronic device holder that comprises a first diagonally opposed strap connector that secures over the four corners of the electronic device, and a second connector that provides a swivel means from the base of the holder. Similar to the Yang disclosure, the Nelson device fails to disclose a glove attachment means to the electronic device holder that allows a user to freely support the device with one hand and disconnect therefrom as desired while retaining the connection means within the palm of the user's hand.

The present invention provides a means to support a tablet computer without requiring the user to manually grip the device, while also providing a means to readily pivot the tablet in the supported hand. It is submitted that the present invention is substantially divergent in design elements from the prior art, and consequently it is clear that there is a need in the art for an improvement to existing tablet support devices. In this regard the instant invention substantially fulfills these needs.

### SUMMARY OF THE INVENTION

In view of the foregoing disadvantages inherent in the known types of tablet supports now present in the prior art, the present invention provides a new tablet support device that can be utilized for providing convenience for the user when supporting a tablet computer without gripping the device and using a single hand, while the second hand is free to interact with the tablet or manipulate other items as desired.

It is therefore an object of the present invention to provide a new and improved tablet support device that has all of the advantages of the prior art and none of the disadvantages.

It is another object of the present invention to provide a tablet support device to provide a one-handed, pivotable support for a tablet computer device that gives freedom to the user's second hand.

Another object of the present invention is to provide a tablet support device that provides a means of support for a tablet computer that does not require the user to grip the tablet or exert any force thereon, but rather one that secures to the user's open hand for comfortable support of the tablet without straining.

Yet another object of the present invention is to provide a tablet support device that provides a standing user with the ability to both support the device and simultaneously make inputs.

Another object of the present invention is to provide a tablet support device that secures to the backside of a tablet computer and provides a removable handgrip securable thereto.

A final object of the present invention is to provide a tablet support device that is ideal for instructors, teachers, professionals, and for everyday users desiring to reduce the strain placed on the user to simultaneously hold and interact with the tablet.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a backside perspective view of the preferred embodiment of the present invention in a disconnected state.

FIG. 2 shows a backside view of the present invention.

FIG. 3 shows a side view of the present invention.

FIG. 4 show a backside perspective view of the present invention in a working state.

FIG. 5 shows an alternate embodiment of the present invention.

### DETAILED DESCRIPTION OF THE INVENTION

Reference is made herein to the attached drawings. Like reference numerals are used throughout the drawings to depict like or similar elements of the tablet support device. For the purposes of presenting a brief and clear description of the present invention, the preferred embodiment will be discussed as used for supporting a tablet computer with a single hand and with no gripping forces. The figures are intended for representative purposes only and should not be considered to be limiting in any respect.

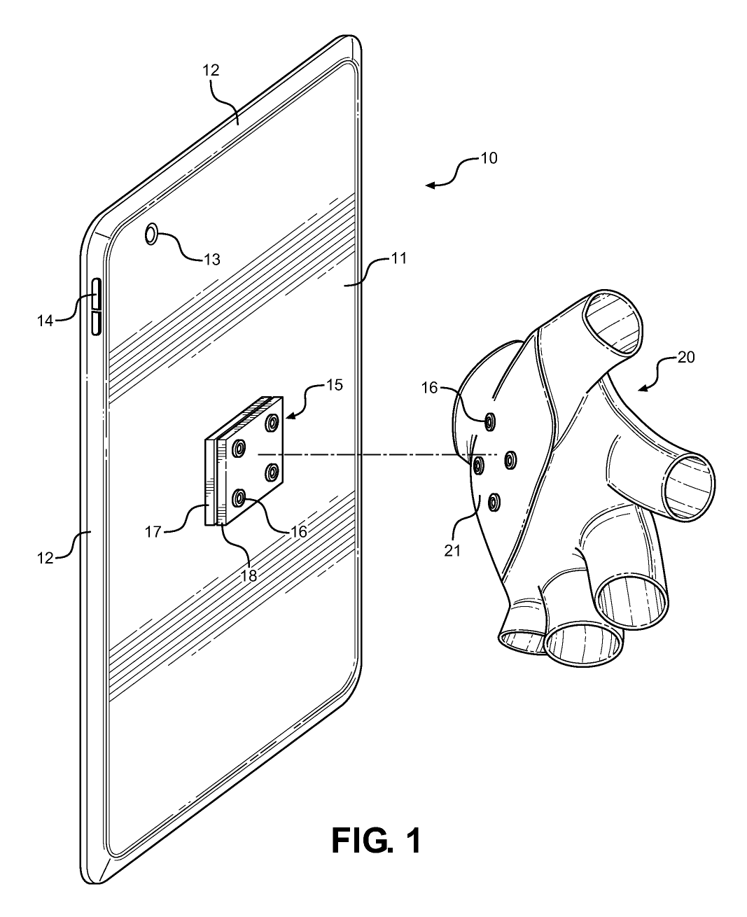

Referring now to FIG. 1, there is shown a backside perspective view of the present tablet support device. The device comprises a frame 10 having a backside surface 11 and a raised peripheral edge 12 that surrounds the perimeter of the tablet chassis to secure the frame 10 thereto. The raised edge 12 includes an upstanding structure that extends from the frame backside surface 11 to wrap around the tablet perimeter and terminate in an inwardly directed lip. The lip encases the tablet within the frame interior and prevents separation of the frame 10 and the tablet. This attachment design is well understood in the art of tablet protectors and covers, and is one that relies on the dimensions of the tablet relative to the frame to ensure the tablet is firmly secured within the frame interior by the lip and the two remain connected. Proper fitment is required to ensure the two members secure together. Apertures in the frame 10 include camera lens ports 13 and user input ports 14 that are also dependent upon the design of the tablet.

Along the backside surface 11 of the frame 10 and centrally mounted thereto is a pivoting mechanism 15 that comprises an inner 17 and outer 18 member that are pivotably connected to one another to allow relative rotation of the members in a plane parallel to the frame backside surface 11. The inner member 17 is securely fastened to the frame and is statically connected thereto. The outer member 16 connects to the inner member 17 using a pinned revolute joint connection, whereby the outer member 16 is capable being spun freely with respect to the inner member 17. A connecting pin or post provides the connection therebetween. Along the outer surface of the outer member is a connector means 16 or plurality thereof, whereby the connectors provide the user with the ability to secure a strap or support member 20 thereto using corresponding connector elements 16.

The goal of the present invention is to provide a one-handed tablet support that does not require any gripping force input by the user to hold, interrogate, and display the tablet. In the preferred embodiment, the pivot mechanism 15 is connected to a user's palm by way of a glove support member 20. The glove is donned on the left or right hand of a user, whereby a pivot joint out member connection means 16 is positioned within the palm 21 of the glove 20. In this way, the user can don the glove, 20, and snap or otherwise secure the frame to the glove to provide support for the frame without gripping the tablet perimeter or balancing it with one hand along its backside. The glove 20 can be a formed structure or a form-fitting, flexible structure that stretches to different sized hands. Further, the connection means may be provided along the one side 21 of the glove 20, or along both sides to provide for ambidextrous use, whereby the palm of the user can face either direction for right handed or left handed use.

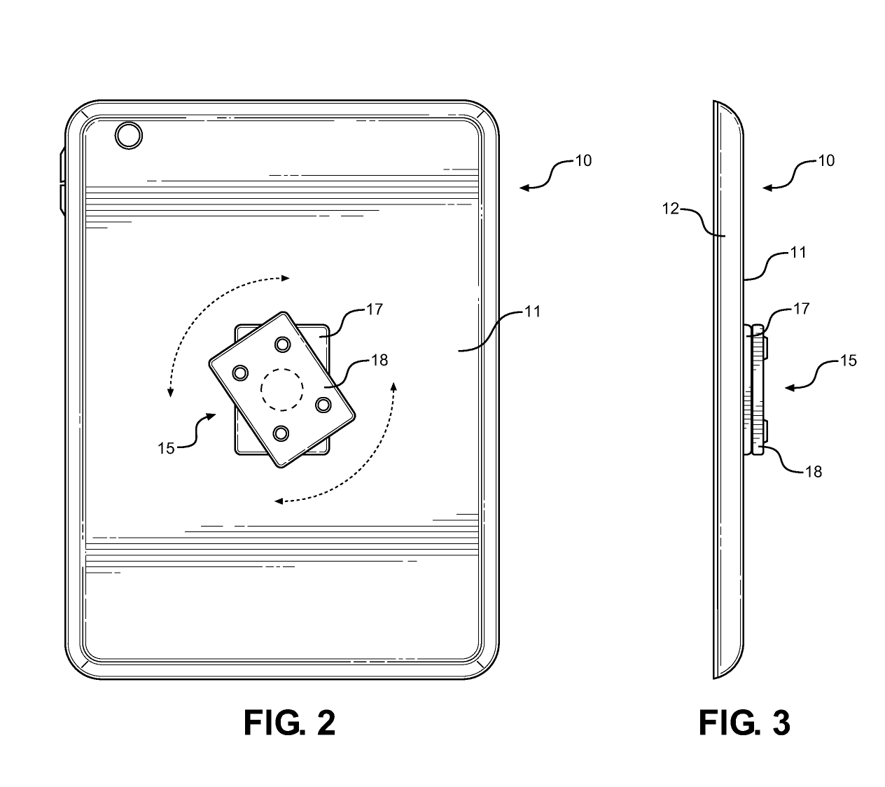

Referring now to FIG. 2, there is shown a rear view of the present tablet support device. In this view, the operation of the pivot mechanism 15 is clearly visualized. The tablet frame 10 provides a bare backside surface 11 upon which the pivot mechanism is centrally placed, providing balance for the user when supporting the tablet with a single hand. The outer member 18 connects to the user's palm and the inner member 17 secures to the frame 10, whereby the frame 10 can be freely rotated relative to the user's palm during use. This allows the user to view the tablet in either landscape or portrait orientation without disconnecting the frame from the user's supporting hand.

Referring now to FIG. 3, there is shown a side view of the present invention, whereby the thickness of the device and the design of the frame are more clearly visualized. The frame upstanding edges 12 form around the perimeter of the tablet device and an inwardly directed lip secures the tablet within the frame 10 open interior while the two are connected. The pivot mechanism 15 extends from the backside surface 11 of the frame 10 and provides connection to a user's palm such that the frame and tablet are readily handled with one hand.

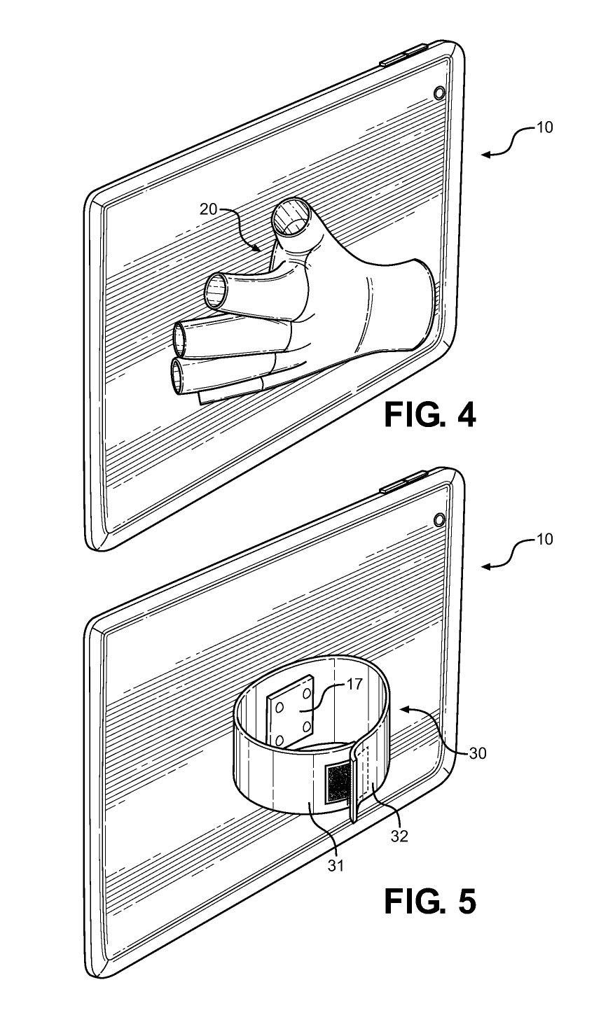

Referring now to FIGS. 4 and 5, there are shown two rear perspective views of the present invention in a working state, whereby a first and second embodiment for the user hand engagement element is provided. In the first and preferred embodiment, the glove 20 forms over a user's hand and provides connection to the frame 10 pivot mechanism at the palm of the glove. In the second embodiment, a strap connector 30 is provided, whereby the strap comprises a first 32 and second 31 separable length securable at their ends using hook and loop fastening, snaps, or similar connectors. The strap 30 may further be a continuous loop of elastic material that forms around the backside of a user's hand while their palm is in contact with the pivot mechanism exterior member 17. In both the glove and strap embodiment, the connectors are removably attached to provide the user with a frame 10 that can operate independently from the hand engagement element.

The present invention describes a no-grip, single-handed tablet support for holding an electronic tablet computer. The device comprises a hand engagement element that eliminates the need for a user to grip the tablet or strain to support it in one hand. The hand engagement element preferably comprises a fingerless glove with a snap attachment on the palm that can fit into corresponding snap connectors on the outer member of the tablet's pivot mechanism. This can also be a full-fingered glove element or a strap element. The glove can be made to fit left and right handed men, women and children. It is designed to prevent users from becoming fatigued after holding the device for long periods of time, or provide relief for people who suffer from carpal tunnel syndrome and find it difficult to hold onto a tablet. The frame of the device is comprised of a formed and hardened material that acts as a protector cover for the tablet while thereattached. Several materials and designs for the frame are contemplated. It is not desired to limit the present invention to a single design or a single material, but rather it is desired to disclose a tablet support device that offers improved ergonomics for handling a tablet computer and a protective case therefor.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A one-handed, open grip, and pivotable tablet computer support device,
a tablet support frame having a backside surface, an upstanding peripheral edge forming an open interior, and a lip extending inward from said peripheral edge;
a pivot mechanism centrally located along said frame backside surface, said mechanism comprising a revolute joint;
a hand engagement element securing to a user's open hand and having connectors for removably attaching said hand engagement element to said pivot mechanism.

2. The device of claim 1, wherein said pivot mechanism further comprises an inner member and an outer member pivotably connected by said revolute joint to allow relative rotation of each member.

3. The device of claim 1, wherein said hand engagement element comprises a hand glove having said pivot mechanism connectors along said glove palm region.

4. The device of claim 3, wherein said glove is a form-fitting, elastic material.

5. The device of claim 3, wherein said glove is a hardened material.

6. The device of claim 3, wherein said glove comprises open finger holes.

7. The device of claim 3, wherein said glove comprises a first and second opposed palm region each with connectors thereon to provide an ambidextrous hand engagement element.

8. The device of claim 1, wherein said hand engagement element comprises a strap element to surround a user's hand, said strap having said pivot mechanism connectors along an outer surface thereof.

9. The device of claim 8, wherein said strap element further comprises a continuous loop.

10. The device of claim 8, wherein said strap element further comprises a first and second strap length having strap end securement means at each strap length end to form a closed loop.
